(19) United States
(12) Patent Application Publication
(10) Pub. No.: US 2007/0033854 A1
(43) Pub. Date: Feb. 15, 2007

(54) Frameless portable hunting blind/ice fishing hut that absorbs sounds and scent with carry/storage case

(76) Inventor: Glenn Fielding Ridge, Cumming, GA (US)

Correspondence Address: Glenn F. Ridge, 1353 Hester Dr., Cumming, GA, 30040, US

(21) Appl. No.: 11/456,681

(22) Filed: Jul. 11, 2006

Related U.S. Application Data
(60) Provisional application No. 60/698,602, filed on Jul. 11, 2005.

(51) Int. Cl. A01M 31/00

(52) U.S. Cl. 43/1

(57) ABSTRACT

The invention is a frameless portable hunting blind/ice fishing hut that absorbs sounds, and scent with carry/storage case. The hunting blind/ice fishing hut, is a enclosed room-like structure with or without a tree break-up pattern on the exterior and having at least two wall panels forming at least four walls with at least one horizontal lift-up and or sliding window in each wall that open and close, a door that opens outward, an interior and a roof panel with outer fitting cornice is supported and anchored on ground surface or ice surface. The hunting blind is able to conceal at least one hunters/occupants within its structure, absorbs sounds, and scent from within eliminating the possibility of detection by animal's keen sense of sight, hearing and smell while keeping the occupants out of the harsh weather. The hunting blind/ice fishing hut allows said hunters/occupants ease of transport from location to location within minutes by a hand carried carrying/storage case, ease of assembly

### RELATED U.S. PATENT DOCUMENTS

| | | |
|---|---|---|
| Patent No.: | Date: | Inventors: |

Related U.S. Patent Documents

| | | | |
|---|---|---|---|
| Current U.S. Class: | | | |
| 135/901 | 4794717 | January, 1998 | Horsmann |
| 135/901 | 4798019 | January 1998 | Sury et al. |
| 135/901 | 6553725 | April, 2003 | Washington |
| 135/117 | 5371966 | September, 1994 | Hall |
| | 5592960 | January, 1997 | Williams |

Foreign Patent Documents

| | | | |
|---|---|---|---|
| | 8603319 | July, 1988 | N L |
| | 54220 | July, 1912 | A T. |
| | 348230 | September, 1960 | C H. |
| | 2-272126 | November, 1990 | J P. |
| Intern'l Class: | | | |

A01M031/02, E04H015/02, A45F001/16, A0HM031/02

### BACKGROUND Of THE INVENTION

1. Field of the Invention

This present invention relates to portable hunting blinds/ice fishing huts. Specifically, the invention is a portable enclosed ground, turkey, waterfowl and big game hunting blinds and has an outer surface that blends in with the woodlands, lightweight, a interior that absorbs sounds, and the absorption of hunters/occupants scent, eliminating the possibility of animal detection by their keen sense of sight, sound and smell, drop-down and or sliding windows, able to unfold for assembly and to fold flat for disassembly, allowing blind to be placed into a box shaped hand held carrying/storage case, which can be used as a storage container to store hunters occupants gear.

2. Description of the Art

The art to which the present invention relates includes enclosures, shelters, blinds, ice fishing huts and stands for use by hunters, wildlife observers. Commonly made of fabric materials with metal frames, plastic board or card board of inferior walls, floor, roof, assembly, design and having a multitude in combination of fasteners, screws and velcro strips used in the assembly/setup process. These enclosures, shelters, blinds, stands require the occupant to assume an uncomfortable sitting or kneeling position and then open windows using twine inwardly and or outwardly and or stand lip to harvest the animal as they approach the blind, this movement can be seen by the animal and will alert them to the hunters present and frighten the animal away.

Most enclosures, shelters, blinds, stands do not have interior insulation to protect the occupants from the extreme cold and rainy weather and or the animals sense of hearing, sight and smell and they are not easily transported and assembled. They are designed primarily to fool the animals sight and or smell only. Conversely, the present invention is designed for ease of transport, assembly, lightweight, eliminates the possibility of animals detection by their keen sense of sight, hearing and smell while keeping the occupants out of the harsh weather elements.

There are several patents, which disclose enclosures, shelters, blinds, and stands of various constructions.

Washington, U.S. Pat. No. 6,553,725 discloses a lightweight, collapsible, portable enclosure for a hunters, bird watchers, field observers and the like. Having at least three walls, top cover, bottom pan and at least one of the walls has opening for ingress and egress and windows, used by hunters awaiting animals to approach wherein the hunter and enclosure are preferably camouflaged.

Hall, U.S. Pat. No. 5,241,772 discloses a hollow cylindrical hunting blind, supported on the ground or on a tower. Formed of elongate molded panels and a domed roof that has a rain channel to capture and direct rain water downwardly between the windows, an a outer surface corrugations simulating the bark of a tree a small peep window above the lower windows an a flexible cable having a control knob opens and closes windows. Mounted in the enclosure a swivel chairs, and a ladder-stand connected to the tower can be disconnected to serve as a leaning tree stand that a hunter can climb tip to hunt from.

Horsmann, U.S. Pat. No. 4,794,717 discloses a hunting blind shaped like a bale of hay comprising tenting material covering a tubular frame.

Sury, U.S. Pat. No 4,798,019 discloses a box-shape blind having a tubular frame and fabric covering. The top is see through, and the sides have loops for holding surrounding vegetation to disguise the blind.

None of the above inventions and patents taken either singularly or combination, is seen to describe the instant invention as claimed. Thus a big game hunting blind/fishing house solving the aforementioned problems is desired.

### SUMMARY OF THE INVENTION

The present invention is a lightweight thermal insulated, sound and scent absorbing portable enclosed ground, turkey, waterfowl, big game hunting blind and ice fishing hut, with or without a tree break-up pattern on the exterior resembles a tree line and the surrounding woodlands.

The hunting blind/ice fishing hut, comprises two wall panels forming four walls with one horizontal lift-up and or sliding window in each wall that open and closes, a door in one wall that opens outward an interior and a roof panel with outer fitting cornice for concealing hunters/occupants, absorbs sounds and scent from within eliminating the possibility of detection by animal's keen sense of sight, hearing and smell.

It is an object of the invention to provide breakup and concealment of the hunters/occupants body, allowing the hunters/occupants freedom of movement within the hunting blind, without the animal's awareness by its keen sense of sight, hearing and smell.

It is an object of the invention to provide hunters/occupants the ability to talk within the hunting blind, without the animal's awareness by its keen sense of hearing.

It is an object of the invention to provide the combination of the high-density polyethylene corrugated plastic for the exterior panels with the scent absorbing fiber filament inserts, inserted into the interior around and or below the windows and roof panel. Providing the invention primary multiplicity of purpose thereby forming a thermal insulated air barrier that insulates against the extreme cold and rainy weather, absorbs all interior sounds and eliminates the hunters/occupants scent by absorption, eliminating the possibility of detection by animal's keen sense of sight, hearing and smell.

It also provides the invention the lightest in weight for its class as a portable hurting blind/ice fishing hut, supported and anchored directly to the ground and or ice covered lake/river surfaces.

It is another object of the invention to provide the natural scent of the ground to diffuses within the hunting blind.

The primary purpose is performed with the windows open and or closed, allowing the hunters/occupants a worry free hunt,

It is an object of the invention to provide the hunter/occupants the ability to ice fish on top of frozen lakes and rivers while being protected from the harsh, cold and rainy weather.

It is an object of the invention to provide the hunter/occupants the ability to be completely out of the weathers environmental elements, being completely enclosed inside the hunting blind.

It is an object of the invention to provide lift-tip and or sliding windows allowing the hunters to open and place a rifle outside of the blind with very little unseen movement to harvest big game and to close after the harvest.

It is an object of the invention to provide improved elements and arrangements thereof for the purposes described which is fully effective and dependable in accomplishing its intended purposes.

These and other objects of said present invention will become readily apparent upon further review of the following specification and drawings.

### BRIEF DESCRIPTION OF THE DRAWINGS

FIG. 1 is an perspective view of preferred embodiment of the fameless portable hunting blind/ice fishing hut that absorbs sounds, and scent of this present invention shown fully assemble

FIG. 1A is an exploded perspective view of preferred embodiment of the fameless portable hunting blind/ice fishing hut that absorbs sounds, and scent of this present invention.

FIG. 2 is an exploded perspective view of one embodiment of the fameless portable hunting blind/ice fishing hut that absorbs sounds, and scent showing the components of the wall panel of this present invention.

FIG. 2A is an exploded perspective view of one embodiment of the a fameless portable hunting blind/ice fishing hut that absorbs sounds, and scent showing the assembly components of the wall panel with door of this present invention.

FIG. 3 is an exploded perspective view of one embodiment of the fameless portable hunting blind/ice fishing hut that absorbs sounds, and scent showing the assembly components of the horizontal lift-up windows of this present invention.

FIG. 4 is an exploded perspective view of one embodiment of the fameless portable hunting blind/ice fishing hut that absorbs sounds, and scent showing the unfolded flat roof panel of this present invention.

FIG. 4A is an perspective view of one embodiment of the fameless portable hunting blind/ice fishing hut that absorbs sounds, and scent showing the assemble roof panel of this present invention.

FIG. 5 is an perspective view of preferred embodiment of the fameless portable hunting blind/ice fishing hut that absorbs sounds, and scent with carry/storage case showing the frameless portable only hunting blind that assimilate sounds, diffuses scent and an ice fishing hut wall panel with door, wall panel and the roof panel unassembled and folding-up going into the carrying/storage case of this present invention.

FIG. 5A and FIG. 5B is an perspective view of preferred embodiment of the fameless portable hunting blind/ice fishing hut that absorbs sounds, and scent with carry/storage case showing FIG. 5A the carry/storage case closing and FIG. 5B the carry/storage case closed with the fameless portable hunting blind/ice fishing hut that absorbs sounds, and scent inside and ready to be hand carried to hunting and or fishing location to be assemble for use of this present invention.

### DETAILED DESCRIPTION OF THE PREFERRED EMBODIMENTS

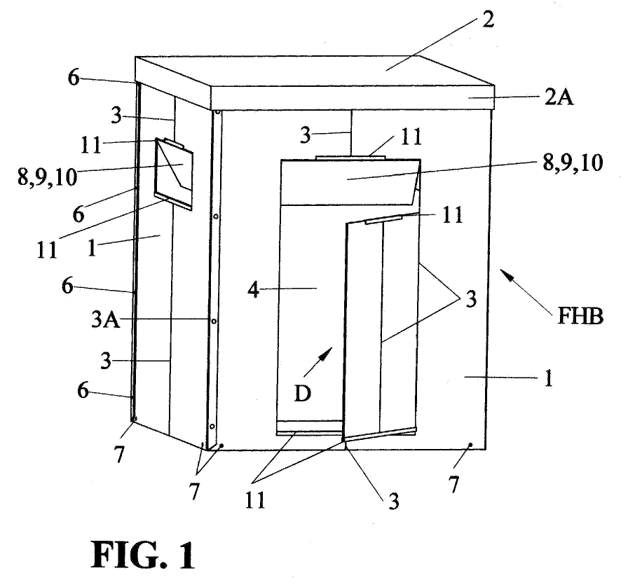

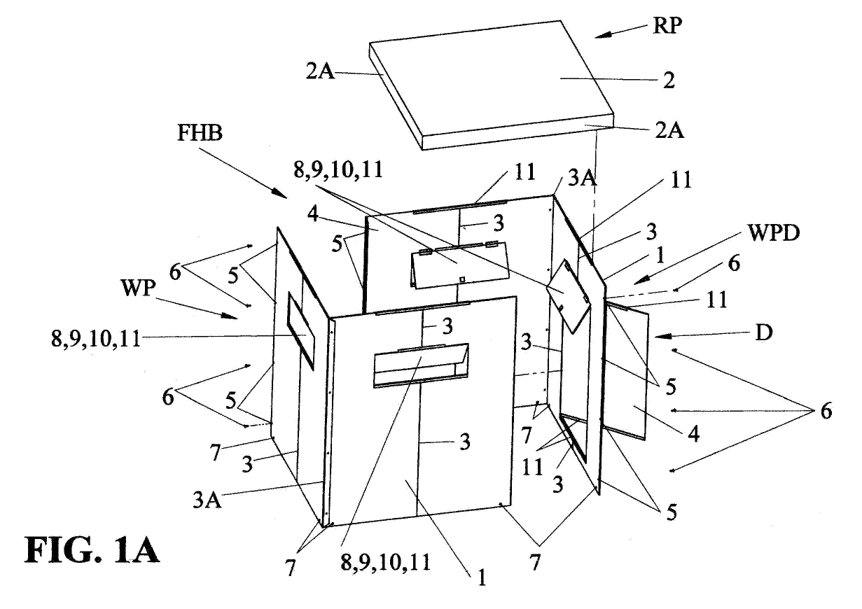

Referring to FIG. 1 and FIG. 1A the present invention, a preferred embodiment of a frameless portable hunting blind/ice fishing hut FHB that absorbs sounds, and scent FHB with carry/storage case CSC. FIG. 1, showing the frameless portable hunting blind/ice fishing hut FHB that absorbs sounds, and scent fully assembled showing the windows 9 opening inward and door D opening outward with ground or ice surface anchor holes 7.

As shown in FIG. 1A a wall panel WP, wall panel with door WPD, with the door D opening outward, windows 9 opening inward, interior with scent absorbing fiber filament inserts 4 and the roof panel RP outer fitted cornice 2A being assembled. The wall panel WP consists of a wall of corrugated plastic panel that forms two walls within the one wall panel WP and having one opening for a window 9 in each wall. Connecting the two walls at their corner is the wall corner scored junction 3A and running vertically in the center of the walls are score indentation 3 allowing the wall panel WP to fold for storage or unfold for assembly along the vertical scored areas in the wall panel WP.

The wall panel with door WPD consists of a wall of corrugated plastic panel that forms two walls with one wall having, a door D within the one wall panel with door WPD and having one opening for a window 9 in each wall. Connecting the two walls at their corner is the wall corner scored junction 3A and running vertically in the center of the walls and door D are score indentation 3 allowing the wall panel with door WPD to fold for storage or unfold for assembly along the vertical scored areas in the wall panel with door WPD.

The roof panel RP with outer fitted cornice 2A consists of a roof of corrugated plastic panel 2 and when assembled together with the wall panel WP and the wall panel with door WPD of four walls of corrugated plastic panels 1 forms the enclosed frameless room-like structure.

The wall panel WP and wall panel with door WPD are unfolded flat for assembly along the score indentation 3 that runs vertical on the walls. The walls are braced using self-grippinig U-channel bracing 11 fastened along the top horizontal edge of each wall, bottom and top horizontal edges of the openings for the windows 9 and along the top horizontal edge of the opening for the window 9 above the door D, the bottom horizontal edge of the opening for the door D and the door D is braced with U-channel bracing 11 on the top and bottom horizontal edges.

The U-channel bracing 11 is used to prevent the wall panels WP and door D from folding back onto its self while being assembled and it provides additional strength to the structure. After the U-channel bracing 11 has been put into place in all of the openings for the windows 9, the windows 9 with self-gripping U-channel hinges 8 are installed along the top horizontal edge of the opening, this will allow the windows 9 to open up inward and locking the windows 9 into place open or closed using the locking tab 10.

The wall of corrugated plastic panels 1 forming two walls having U-channel bracing 11, windows 9 and the interior having scent absorbing fiber filament inserts 4. The other wall of corrugated plastic panels 1 forming two walls, having U-channel bracing 11, windows 9 and the interior having scent absorbing fiber filament inserts 4 with one wall having a door D. The two walls of corrugated plastic panels 1 forming two walls each are folded inward and opposite of each other to form two 90-degree angled outer corners at the wall corner scored junction 3A and two outer vertical opposite edges having fastener holes 5.

The two wall of corrugated plastic panels 1 forming two walls each with one having a door D are fayed together along the two opposite outer vertical edges having fastener holes 5 with nylon fasteners 6 through the fastener holes 5 opposite and adjacent of each other, to form a frameless room-like structure.

Then the roof of corrugated plastic panel 2 with four outer edges is unfolded flat and assembled, folding the four outer edges inwardly and locked in place with fasteners to form outer fitted cornice 2A. The assembled Roof panel RP is then sleeved downwardly onto and around the top outer horizontal edges of the four walls of the enclosed frameless room-like structure. When fully assembled the frameless portable hunting blind that assimilate sounds diffuses scent and an ice fishing hut FHB showing the windows 9 opening inward and door D opening outward, containing anchor holes 7 along the bottom horizontal edges used for anchoring the structure it the ground or ice surface of this present invention.

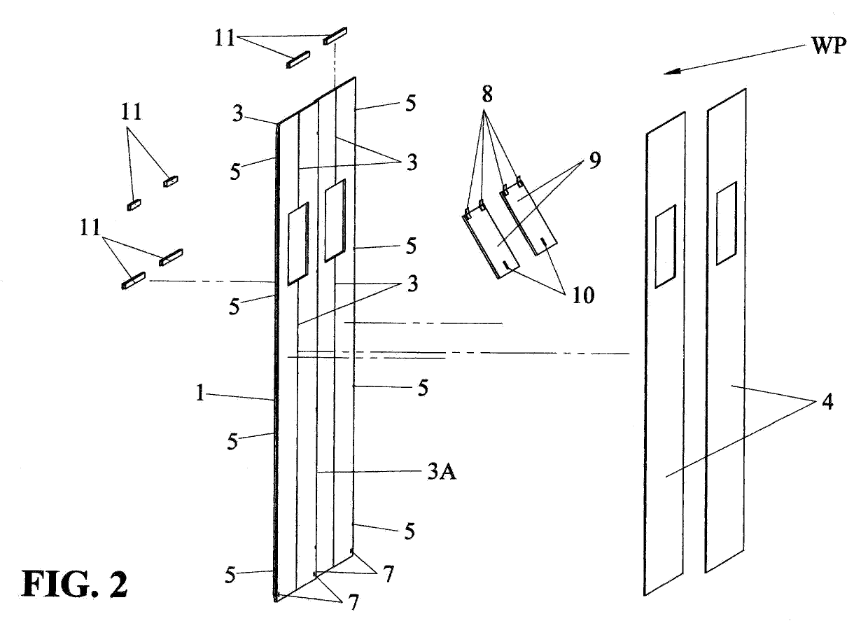

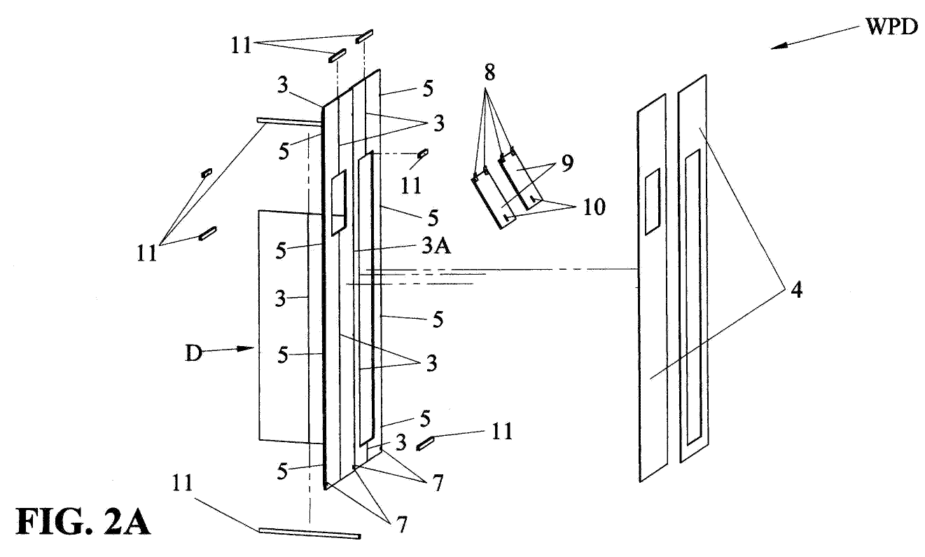

In the preferred embodiment shown in FIG. 2 and FIG. 2A an exploded perspective showing the contents and assembly process of the wall panel WP in FIG. 2 and the assembly process of the wall panel with door WPD.

FIG. 2 showing wall of corrugated plastic panels 1, score indentation 3, wall corner scored junction 3A fastener holes 5, anchor holes 7, U-channel bracing 11, windows 9, U-channel hinges 8, locking tabs 10 and scent absorbing fiber filament inserts 4. The assembly of the wall panel WP with the scent absorbing fiber filament inserts 4 attached are unfolded after being removed from the carry/storage case CSC at the score indentation 3 and wall corner scored junction 3A flat. The self-gripping U-channel bracing 11 are fastened along the top horizontal edge of each wall and the bottom and top horizontal edges of the openings for the windows 9. The windows 9 with the installation of the self-gripping U-channel hinges 8 and the locking tabs 10 are installed along the top horizontal edge of the openings for the windows 9 of this present invention.

FIG. 2A showing wall of corrugated plastic panels 1, door D, score indentation 3, wall corner scored junction 3A, fastener holes 5, anchor holes 7, U-channel bracing 11, windows 9, U-channel hinges 8, locking tabs 10 and scent absorbing fiber filament inserts 4. The assembly of the wall panel with door WPD with the scent absorbing fiber filament inserts 4 attached are unfolded after being removed from the carry/storage case CSC at the score indentation 3 and wall corner scored junction 3A flat. The self-gripping U-channel bracing 11 are fastened along the top horizontal edge of each wall, the top horizontal edge of the opening for the windows 9 above the door D, the bottom horizontal edge of the opening for the door D and the door D is braced with U-channel bracing 11 on the top and bottom horizontal edges. The windows 9 with the installation of the self-gripping U-channel hinges 8 and the locking tabs 10 are installed along the top horizontal edge of the openings for the windows 9.

As shown in FIG. 1A the wall panel WP and the wall panel with door WPD are folded inward and opposite of each other to form two 90-degree angled outer corners at the wall corner scored junction 3A and two outer vertical opposite edges having fastener holes 5 and fayed together along the two opposite outer vertical edges having fastener holes 5 with nylon fasteners 6 through the fastener holes 5 opposite and adjacent of each other forming four walls. The Roof panel RP is then sleeved downwardly onto and around the top outer horizontal edges of the four walls that consists of the two wall panel WP and the wall panel with door WPD forming a enclosed frameless room-like structure of this present invention.

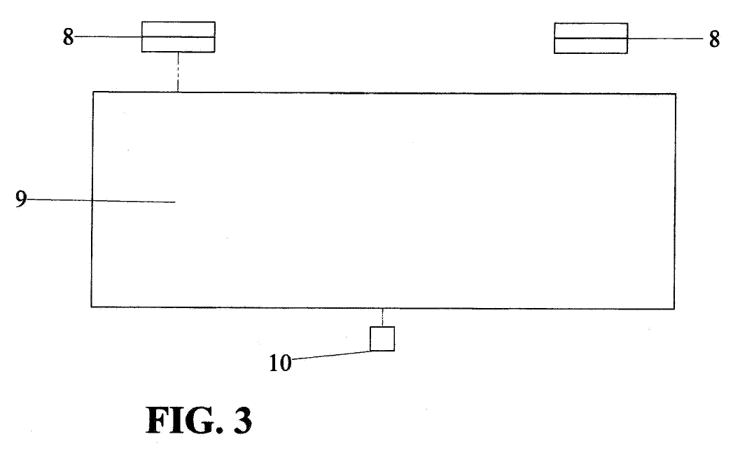

In the preferred embodiment shown in FIG. 3 an exploded perspective showing the contents and assembly process of the window 9, U-channel hinges 8 and the locking tab 10 and how they are assembled together of this present invention.

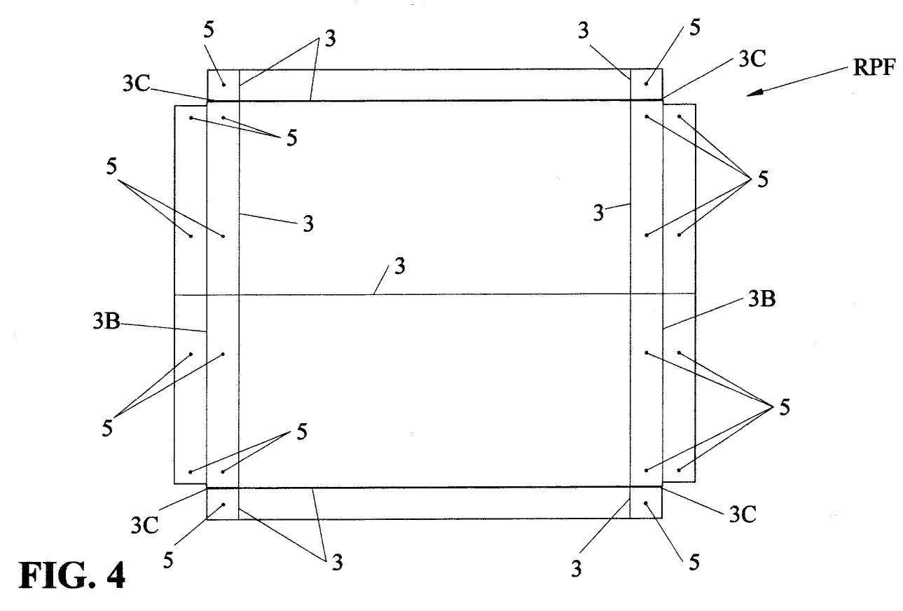

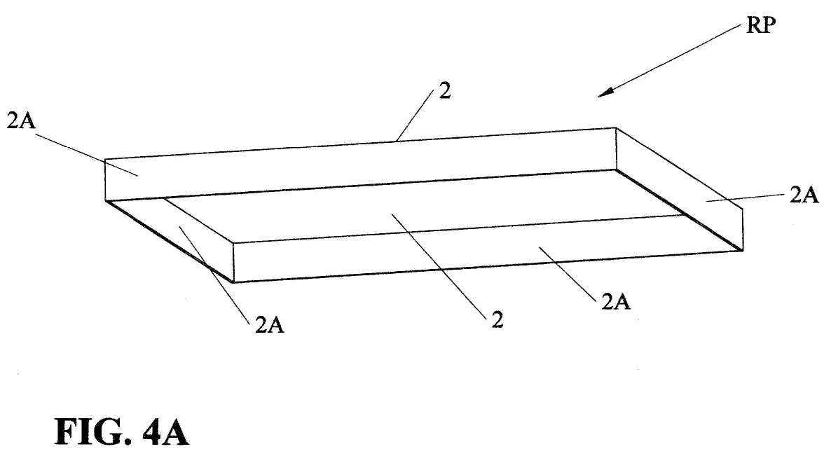

In the preferred embodiment shown in FIG. 4 an flat perspective showing the roof panel RP unfolded with the placement of the score indentation 3 double score indentation 3B, cut out 3C and the fastener holes 5. Along the center score indentation 3 is were the roof panel RP is unfolded to be assembled and folded in half to fix inside the carry/storage case CSC. The outer edges where the score indentation 3 double score indentation 3B, cut out 3C, and the fastener holes 5 are located when folded over on to each other and fastened at the fastener holes 5 to form the outer fitted cornice 2A of the roof panel RP of this present invention.

In the preferred embodiment shown in FIG. 4A the perspective showing the roof panel RP completely assembled and ready to sleeved downwardly onto and around the top outer horizontal edges of the four walls that consists of the two wall panel WP and the wall panel with door WPD shown in FIG. 1A forming a enclosed frameless room-like structure of this present invention.

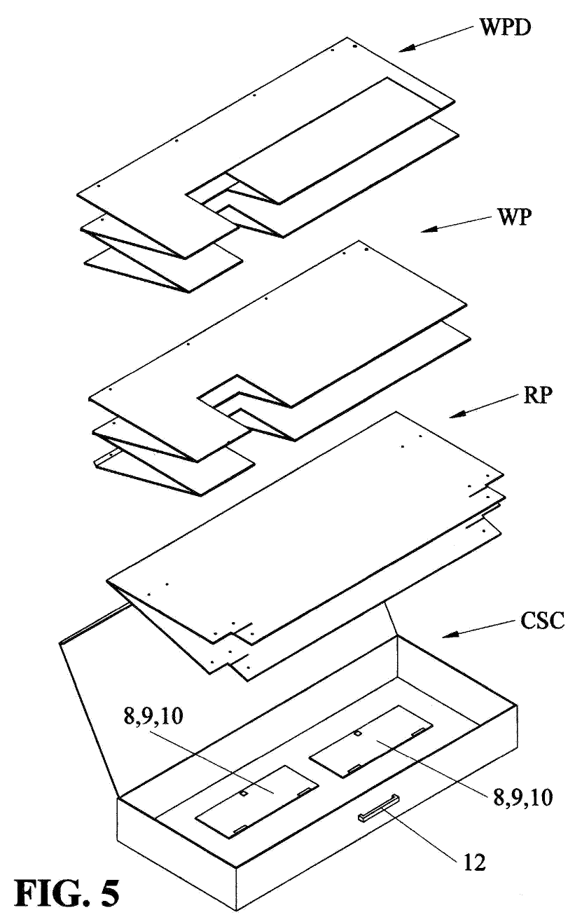

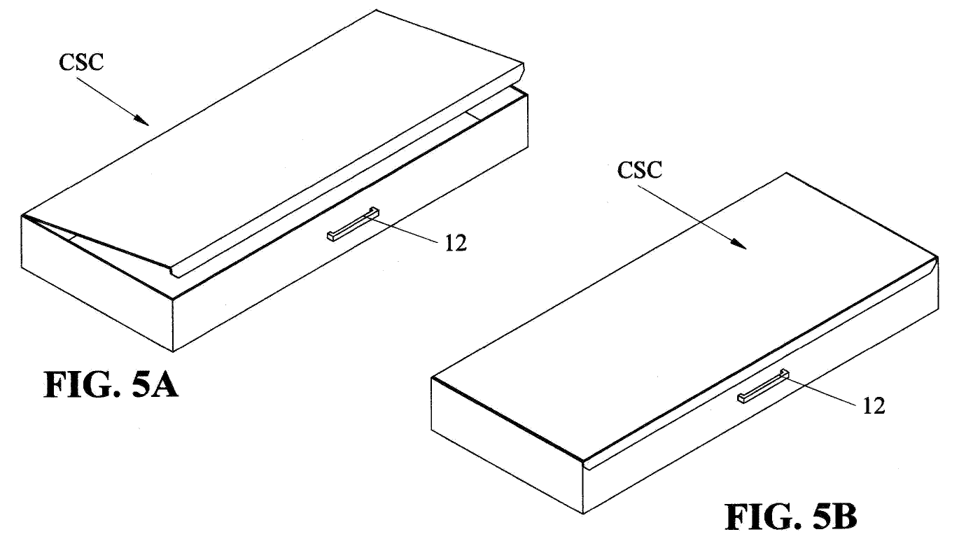

In the preferred embodiment shown in FIG. 5 the perspective of the present invention the fameless portable only hunting blind that assimilate sounds, diffuses scent and an ice fishing hut FHB apart and folding together going into the carry/storage case CSC with handle 12, showing the windows 9 with the U-channel hinges 8 and the locking tab 10 inside the case (not shown are the parts nylon fasteners 6, U-channel bracing 11).

The roof panel RP disassembled and folding in half, the wall panel WP and wall panel with door WPD panels are folding on to it self through a series of scored indentations vertically from top to bottom center of each wall inwardly and outwardly thus comprising a bellows configuration as the wall panel WP and wall panel with door WPD follows the roof panel RP into the carry/storage case CSC with handle 12 of this present invention.

In the preferred embodiment shown in FIG. 5a and FIG. 5B the carry/storage case CSC with handle 12 closing and closed.

Shown in FIG. 5A the carry/storage case CSC with handle 12 closing with the fameless portable hunting blind/ice fishing hut FHB that absorbs sounds, and scent inside.

Shown in FIG. 5B the carry/storage case CSC with handle 12 closed with the fameless portable hunting blind/ice fishing hut FHB that absorbs sounds, and scent of this present invention.

The invention, the fameless portable hunting blind/ice fishing hut that absorbs sounds and scent with or without a tree break up pattern printed on the exterior of said walls resembles a tree line and the surrounding woodlands, has been tested with the inventor inside and has experienced, big game and other animal's coming to feeding around and staying within a yard of the lightweight sound and scent absorption, big game hunting blind/ice fishing hut while having all windows open, for an hour an a half before the big game and other animal's slowly moving off.

It should be understood that the present invention is not restricted to the embodiments described above, but encompasses any and all embodiments within the scope of the following claims.

I claim:

1. A portable only turkey, waterfowl, big game hunting blind and ice fishing hut comprising:
a enclosed room-like structure having at least two wall panels forming at least four walls with at least one horizontal lift-up and or sliding window in each wall that open and close, a door in one wall that opens outward an interior and a roof panel with outer fitted cornice for concealing hunters/occupants, absorbs sounds, and scent from within to eliminate the possibility of detection by animal's keen sense of sight, hearing and smell;
a tree break up pattern printed on the exterior of said walls resembles a tree line and the surrounding woodlands;
said enclosed frameless room-like structure design for ease of assembly/disassembly and transport from location to location within minutes by a hand carried carrying/storage case;
said enclosed frameless room-like structure having two panels forming four walls folding on to its self through a series of scored indentation from top to bottom center of each said wall panel and said walls inwardly and outwardly thus comprising a bellows configuration, forming at least four wall upright panels, door, and interior when assemble;
said enclosed frameless room-like structure having said roof panel folding in half having outer edges that fold inwardly when opened flat to form a fitted cornice when assembled,
said enclosed frameless room-like structure is supported and anchored on ground and or ice covered lake/river surfaces with stakes through anchor holes at the bottom horizontal edges.

2. A portable only turkey, waterfowl, big game hunting blind and ice fishing hut according to claim 1, wherein said wall panels fayed together upright along four adjacent vertical side, top to bottom edges of said walls by nylon fasteners to assemble said enclosed frameless room-like structure with said roof panel to follow,

3. A portable only turkey, waterfowl, big game hunting blind and ice fishing hut according to claim 2, wherein said roof panel unfolding to form a flat roof panel with four outer edges having scored indentation allowing said outer four edges to fold inwardly and lock it place by said fasteners, forming a fitted cornice allowing said roof panel to sleeve downwardly on to said enclosed frameless room-like structure and fayed together by nylon fasteners.

4. A portable only turkey waterfowl, big game hunting blind and ice fishing hut according to claim 1, wherein said enclosed frameless room-like structure has no floor panel yet it is supported and anchored to the ground surface with stakes through anchor holes at the bottom horizontal edge of said two panels forming at least four walls.

5. A portable only turkey, waterfowl, big game hunting blind and ice fishing hut according to claim 2, wherein said two wall panels fayed together upright along four adjacent vertical top to bottom edges, a series of at least four holes along the outer of said vertical top to bottom edges and at least five holes along the top horizontal edge of said two wall panels allowing said fasteners to insert in, to assemble said enclosed frameless room-like structure with said roof panel.

6. A portable only turkey, waterfowl, big game hunting blind and ice fishing hut according to claim 3, wherein said roof panel unfolding to form a flat roof panel with said outer edges forming said fitted cornice, with at least three holes along the length corner to corner of said fitted cornice allowing said roof panel to sleeve downwardly on to said enclosed frameless room-like structure and fayed together by inserting nylon fasteners through said holes of fitted cornice and top horizontal edge of said two panels to assemble.

7. A portable only turkey, waterfowl, big game hunting blind and ice fishing hut according to claim 1, wherein said door in one wall of said wall panel, opens outward allowing the hunters/occupants ease of entry and or exit of said enclosed frameless room-like structure.

8. A portable only turkey, waterfowl, big game hunting blind and ice fishing hut according to claim 1, wherein said at least four walls with at least one horizontal lift-up and or sliding window in each wall that open and close, constructed of a transparent vinyl and or polycarbonate acrylic.

9. A portable only turkey, waterfowl, big game hunting blind and ice fishing hut according to claim 1, wherein said wall panels are constructed of high-density polyethylene corrugated plastic panels, the corrugation of said plastic panels allows air to be trapped within its corrugation thereby forming a thermal insulated air barrier allowing said panels to absorbs sounds from within and insulates said enclosed frameless room-like structure, thereby eliminating the possibility of detection by animals sense of hearing and providing said hunters/occupants greater retention of heat in cold and or rainy weather, within said interior.

10. A portable only turkey, waterfowl, big game hunting blind and ice fishing hut according to claim 1, wherein said interior of said panels of said enclosed frameless room-like structure, around and or below the interior of each window and interior of said wall panels are scent absorbing fiber filament inserts, thereby absorbing said hunters/occupants odors and scent, whereby eliminating the possibility of detection by animnal's sense of smell.

11. A portable only turkey, waterfowl, big game hunting blind and ice fishing hut according to claim 1, wherein combining said corrugated plastic panels and said interior fiber filament inserts, thereby creating additional assimilation of sound around said windows.

12. A portable only turkey, waterfowl, big game hunting blind and ice fishing hut according to claim 1, wherein provides the hunter/occupants the ability to ice fish on top of frozen lakes and rivers while being protected from the harsh, cold and rainy weather.

13. A portable only turkey, waterfowl, big game hunting blind and ice fishing hut according to claim 1, wherein said enclosed frameless room-like structure having two wall panels forming four walls folding on to its self through a series of scores from top to bottom center of each said panel and said parietals inwardly and outwardly and said roof panel able to fold in half thus allowing said structure to unfold for assembly and to fold flat for disassembly, allowing said structure to be placed into a box shaped hand held carrying storage case, constructed of same said high-density polyethylene corrugated plastic for ease of transport from location to location.
